(19) United States
(12) Patent Application Publication
(10) Pub. No.: US 2015/0043354 A1
(43) Pub. Date: Feb. 12, 2015

(54) DIRECT COMMUNICATION SYSTEM

(71) Applicant: Institute For Information Industry, Taipei (TW)

(72) Inventors: Chun-Che CHIEN, Taipei City (TW); Yi-Hsueh TSAI, New Taipei City (TW)

(21) Appl. No.: 14/330,791

(22) Filed: Jul. 14, 2014

Related U.S. Application Data
(60) Provisional application No. 61/863,924, filed on Aug. 9, 2013.

(51) Int. Cl. H04W 72/00; H04W 52/14

(52) U.S. Cl. CPC H04W 72/005; H04W 52/143
USPC 370/241; 370/312

(57) ABSTRACT

A direct communication system and a data forwarding method thereof are provided. The direct communication system includes a first direct communication apparatus and an evolved nodeB, and the first direct communication apparatus belongs to a first direct communication group. The first direct communication apparatus groupcasts a first communication data based on the first direct communication group. After receiving the first communication data, the evolved nodeB receives a first feedback message from a second direct communication apparatus of the first direct communication group. The evolved nodeB decides a re-forwarding of the first communication data in the first direct communication group according to the first feedback message.

### PRIORITY

This application claims priority to U.S. Provisional Patent Application No. 61/863,924 filed on Aug. 9, 2013, which is hereby incorporated by reference herein in its entirety.

### FIELD

The present invention relates to a direct communication system; and more particularly, the direct communication system according to the present invention mainly use an evolved Node B (eNB) to assist in data forwarding of direct communication apparatuses.

### BACKGROUND

In conventional direct communication systems, mobile apparatuses can communicate with each other directly. In this way, exchange of messages can be accomplished in a simple and quick way. Furthermore, the mobile apparatuses may also be divided into groups so that data is forwarded in a groupcast manner.

However, the mobile apparatuses have limited computational capabilities and limited communication coverage, so if the data groupcast communications in a direct communication group are dominated by the mobile apparatuses, the efficiency of groupcast will be greatly affected by the transmission power level of the mobile apparatuses. On the other hand, if the data groupcast communications are dominated by a base station, then the base station needs to process data forwarding of the groupcast data in each mobile apparatus of the direct communication group, and this will cause waste of the system bandwidth resource and remarkably increase the complexity of message processing by the base station to result in a degraded data transmission efficiency.

Accordingly, an urgent need exists in the art to provide a solution capable of improving the effectiveness and efficiency of data forwarding and reducing waste of the network resources while accomplishing the data forwarding between mobile apparatuses in a direct communication group in the existing direct communication system architecture.

### SUMMARY

A primary objective of certain embodiments includes providing a data forwarding method for use in a direct communication system. The direct communication system comprises a first direct communication apparatus belonging to a first direct communication group and an evolved NodeB (eNB). The data forwarding method comprises: (a) enabling the first direct communication apparatus to groupcast a first communication data based on the first direct communication group; (b) enabling the eNB to receive the first communication data; (c) enabling the eNB to receive a first feedback message from a second direct communication apparatus of the first direct communication group after the step (b); and (d) enabling the eNB to decide that the first communication data must be re-forwarded in the first direct communication group according to the first feedback message.

To achieve the aforesaid objective, certain embodiments of the present invention include a direct communication system, which comprises a first direct communication apparatus belonging to a first direct communication group and an eNB. The first direct communication apparatus groupcasts a first communication data based on the first direct communication group. The eNB receives the first communication data and receives a first feedback message from a second direct communication apparatus of the first direct communication group. The eNB further decides that the first communication data must be re-forwarded in the first direct communication group according to the first feedback message.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a direct communication system according to a first embodiment of the present invention;

FIG. 1B is a block diagram of an eNB according to the first embodiment of the present invention;

FIG. 2 is a schematic view of a direct communication system according to a second embodiment of the present invention;

FIG. 3 is a schematic view of a direct communication system according to a third embodiment of the present invention;

FIG. 4 is a schematic view of a direct communication system according to a fourth embodiment of the present invention;

FIG. 5 is a schematic view of a direct communication system according to a fifth embodiment of the present invention;

FIG. 6 is a flowchart diagram of a data forwarding method according to a sixth embodiment of the present invention;

FIG. 7 is a flowchart diagram of a data forwarding method according to a seventh embodiment of the present invention;

FIG. 8 is a flowchart diagram of a data forwarding method according to an eighth embodiment of the present invention;

FIG. 9 is a flowchart diagram of a data forwarding method according to a ninth embodiment of the present invention;

FIG. 10 is a flowchart diagram of a data forwarding method according to a tenth embodiment of the present invention;

FIG. 11 is a flowchart diagram of a data forwarding method according to an eleventh embodiment of the present invention;

FIG. 12 is a flowchart diagram of a data forwarding method according to a twelfth embodiment of the present invention; and

FIG. 13 is a flowchart diagram of a data forwarding method according to a thirteenth embodiment of the present invention.

### DETAILED DESCRIPTION

In the following description, the present invention will be explained with reference to certain example embodiments thereof. However, these example embodiments are not intended to limit the present invention to any specific examples, embodiments, environment, applications or particular implementations described in these example embodiments. Therefore, description of these example embodiments is only for purpose of illustration rather than to limit the present invention. In the following example embodiments and the attached drawings, elements unrelated to the present invention are omitted from depiction; and dimensional relationships among individual elements in the attached drawings are illustrated only for ease of understanding, but not to limit the actual scale.

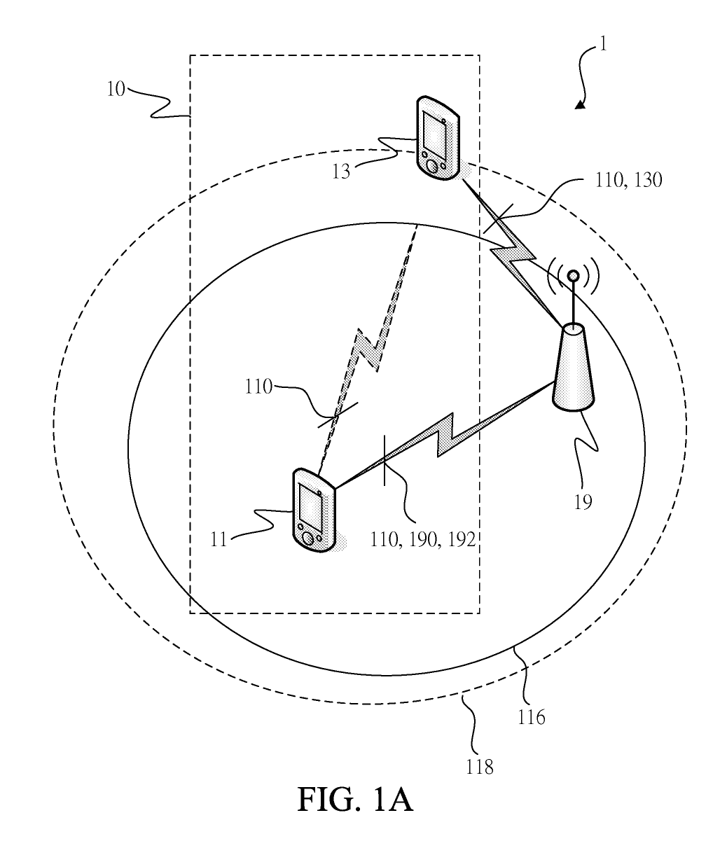

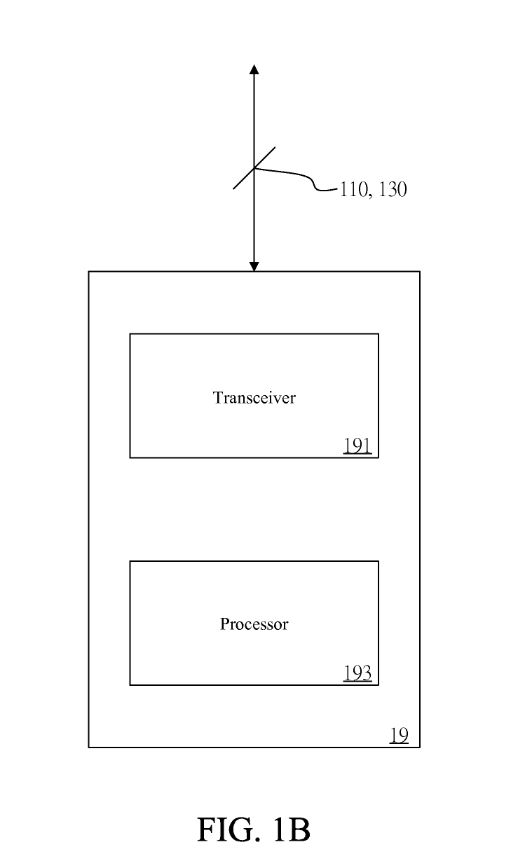

Refer to FIG. 1A and FIG. 1B together. FIG. 1A is a schematic view of a direct communication system 1 according to a first embodiment of the present invention. The direct communication system 1 comprises a first direct communication apparatus 11 and an evolved NodeB (eNB) 19. Both the first direct communication apparatus 11 and a second direct communication apparatus 13 belong to a first direct communication group 10. FIG. 1B is a block diagram of the eNB 19 according to the first embodiment of the present invention. The eNB 19 comprises a transceiver 191 and a processor 193. Interactions between the individual elements will be further described hereinbelow.

Firstly, when the first direct communication apparatus 11 is going to transmit data for communication of the first direct communication group 10 to which it belongs, the first direct communication apparatus 11 directly groupcasts a first communication data 110 based on the first direct communication group 10. Then, because the first communication data 110 is transmitted in a groupcast manner, the first communication data 110 can be received by the eNB 19 via the transceiver 191.

In this case, although the second direct communication apparatus 13 also belongs to the first direct communication group 10, the second direct communication apparatus 13 can not directly receive the first communication data 110 because the second direct communication apparatus 13 is outside a communication coverage 116 of the first direct communication apparatus 11. Accordingly, the second direct communication apparatus 13 will send a first feedback message 130 to the eNB 19 to notify the eNB 19 that it has not received any groupcast message (e.g., the first communication data 110).

It should be particularly noted that, the feedback massage of the present invention comprises the Bit Error Rate (BET), the Channel Quality Indicator (CQI), the Reference Signal Received Power (RSRP), the Reference Signal Received Quality (RSRQ), the Signal to Interference plus Noise Ratio (SINR), the pathloss measurement or other index values adapted to determine the data forwarding quality or the correctness of data forwarding.

Next, after the first feedback message 130 of the second direct communication apparatus 13 is received by the transceiver 191 of the eNB 19, the processor 193 can decide that the first communication data 110 must be re-forwarded in the first direct communication group 10 according to the first feedback message 130. Specifically in the first embodiment, when the processor 193 of the eNB 19 determines that the second direct communication apparatus 13 has not received any groupcast message according to the first feedback message 130, the processor 193 of the eNB 19 can decide that the first communication data 110 must be re-forwarded in the first direct communication group 10 so that the second direct communication apparatus 13 can receive the first communication data 110 in a subsequent data forwarding process.

Further speaking, after the aforesaid eNB 19 decides that the first communication data 110 must be re-forwarded, the eNB 19 which has received the first communication data 110 previously may choose to re-groupcast the first communication data 110 in the first direct communication group 10, or to directly unicast the first communication data 110 to the second direct communication apparatus 13 so that the second direct communication apparatus 13 can obtain the first communication data 110.

Furthermore, in order for the data groupcasted later by the first direct communication apparatus 11 to be received by the second direct communication apparatus 13, the eNB 19 may further notify the first direct communication apparatus 11 to adjust message transmission parameters. Specifically, the reason why the second direct communication apparatus 13 fails to receive messages of the first direct communication apparatus 11 is probably that the second direct communication apparatus 13 is not in the communication coverage 116 of the first direct communication apparatus 11.

Accordingly, when the processor 193 of the eNB 19 determines that the first communication data 110 is not received by the second direct communication apparatus 13 according to the first feedback message 130, the processor 193 of the eNB 19 can transmit a power adjustment message 190 to the first direct communication apparatus 11 via the transceiver 191. The power adjustment message 190 is used to notify the first direct communication apparatus 11 to adjust the message transmission power accordingly so that the communication coverage is expanded into the communication coverage 118 as an attempt to enable messages transmitted later by the first direct communication apparatus 11 to be directly received by the second direct communication apparatus 13.

It should be particularly noted that, the power adjustment may also be done before a direct communication apparatus groupcasts the communication data. For example, before groupcasting a data, a direct communication apparatus may also firstly receive a testing signal (not shown) from another direct communication apparatus of the direct communication group to determine its normal communication distance from the another direct communication apparatus, and then the direct communication apparatus can adjust the message transmission power according to the testing signal. In this way, when the direct communication apparatus groupcasts a communication data, it is ensured that the communication data can be directly received by the other direct communication apparatus.

On the other hand, the second direct communication apparatus 13 can not receive messages of the first direct communication apparatus 11 probably due to a strong interference. Accordingly, when it is determined that the first communication data 110 is not received by the second direct communication apparatus 13 according to the first feedback message 130, the processor 193 of the eNB 19 may also transmit an encoding adjustment message 192 to the first direct communication apparatus 11 via the transceiver 191. The encoding adjustment message 192 is used to notify the first direct communication apparatus 11 to adjust an encoding mode accordingly as an attempt to reduce the interference by changing the encoding mode or adjusting the resource arrangement so that the messages transmitted later by the first direct communication apparatus 11 can be directly received by the second direct communication apparatus 13.

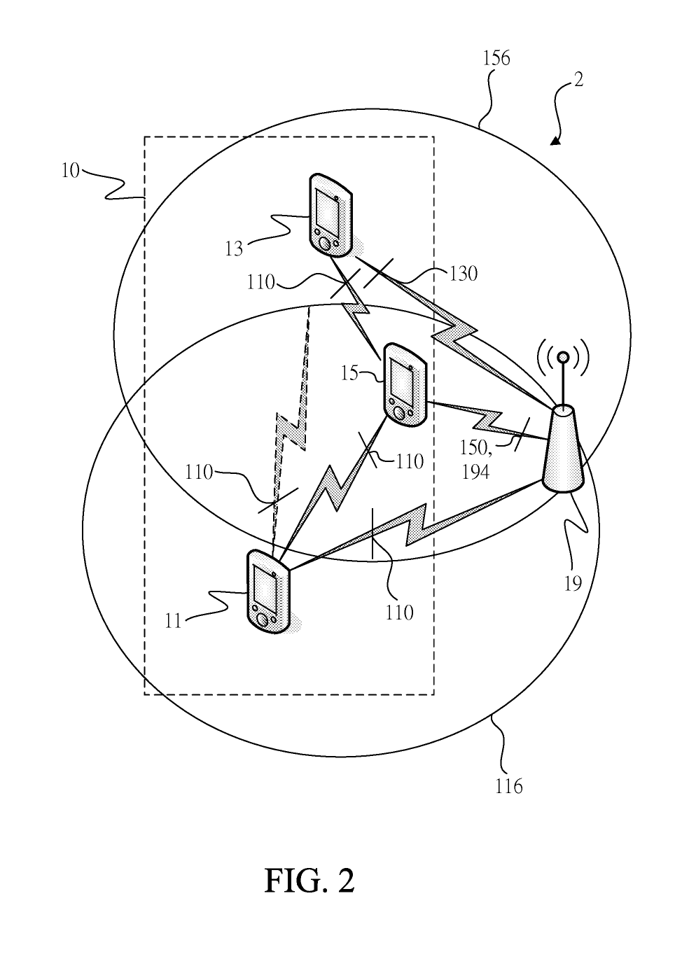

Referring to FIG. 2, there is shown a schematic view of a direct communication system 2 according to a second embodiment of the present invention. It should be particularly noted that, the system architecture and the network connection environment of the second embodiment are identical to those of the previous embodiment, so elements with the same reference numerals also have the same functions and will not be described again. However, the second embodiment differs from the previous embodiment in that, the first direct communication group 10 of the second embodiment further comprises a third direct communication apparatus 15.

Specifically, when the first direct communication apparatus 11 is going to transmit data for communication of the first direct communication group 10 to which it belongs, the first direct communication apparatus 11 directly groupcasts the first communication data 110 based on the first direct communication group 10. Because the first communication data 110 is transmitted in a groupcast manner, the first communication data 110 can be received by the eNB 19 via the transceiver 191.

Then, because the third direct communication apparatus 15 is in the communication coverage 116 of the first direct communication apparatus 11 in the second embodiment, the first communication data 110 can also be received by the third direct communication apparatus 15. Furthermore, although the second direct communication apparatus 13 belongs to the first direct communication group 10, the second direct communication apparatus 13 still can not directly receive the first communication data 110 because the second direct communication apparatus 13 is outside the communication coverage 116 of the first direct communication apparatus 11.

Accordingly, the first feedback message 130 and a second feedback message 150 are transmitted by the second direct communication apparatus 13 and the third direct communication apparatus 15 respectively to the eNB 19 to notify the eNB 19 that the second direct communication apparatus 13 has not received any groupcast message and the third direct communication apparatus 15 has received the first communication data 110.

In other words, after the first feedback message 130 and the second feedback message 150 have been received by the transceiver 191 of the eNB 19, the processor 193 can determine that the first communication data 110 is not received by the second direct communication apparatus 13 according to the first feedback message 130, and determine that the first communication data 110 has been received by the third direct communication apparatus 15 according to the second feedback message 150.

Then, because the eNB 19 has known from the second feedback message 150 that the third direct communication apparatus 15 has the first communication data 110, the eNB 19 can transmit to the third direct communication apparatus 15 a re-forwarding request 194 which notifies the third direct communication apparatus 15 to attempt to transmit the first communication data 110 to the second direct communication apparatus 13. Because the second direct communication apparatus 13 is in a communication coverage 156 of the third direct communication apparatus 15 in the second embodiment, the first communication data 110 forwarded by the third direct communication apparatus 15 can be received by the second direct communication apparatus 13.

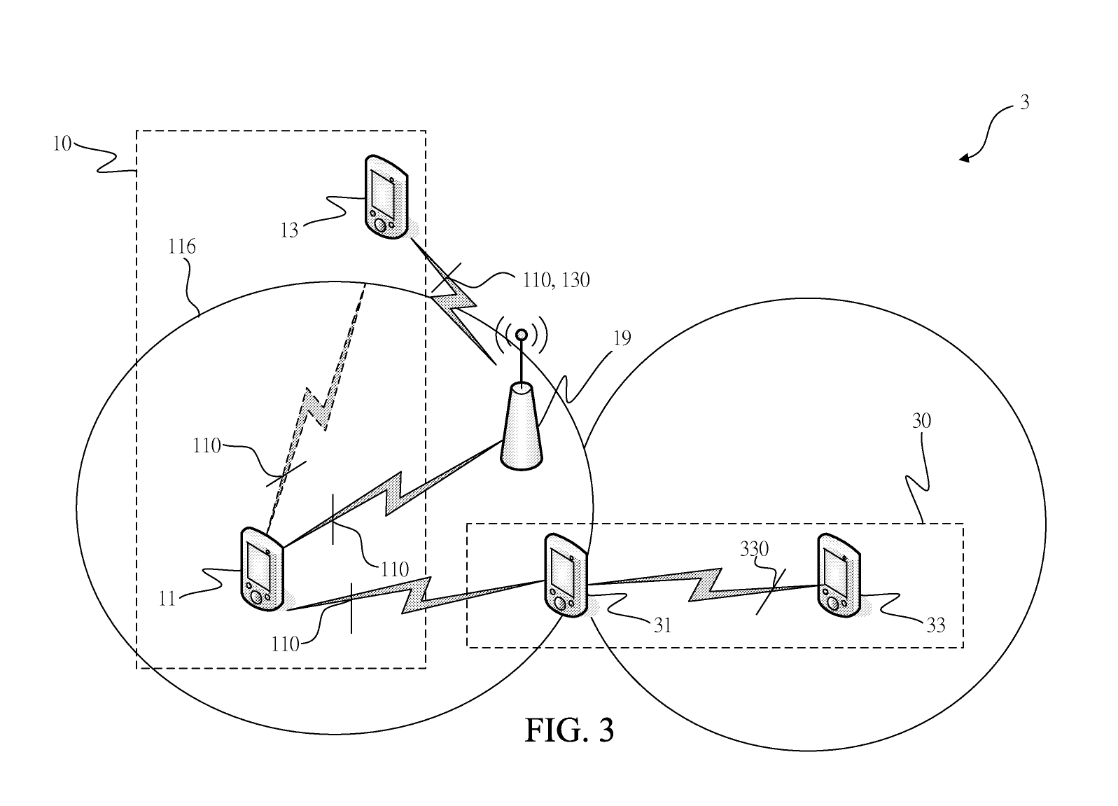

Referring to FIG. 3, there is shown a schematic view of a direct communication system 3 according to a third embodiment of the present invention. It should be particularly noted that, the system architecture and the network connection environment of the third embodiment are identical to those of the previous embodiments, so elements with the same reference numerals also have the same functions and thus will not be described again. However, the third embodiment differs from the previous embodiments in that, the direct communication system 3 further comprises a third direct communication apparatus 31, and both the third direct communication apparatus 31 and a fourth direct communication apparatus 33 belong to a second direct communication group 30.

Specifically, when the first direct communication apparatus 11 is going to transmit data for communication of the first direct communication group 10 to which it belongs, the first direct communication apparatus 11 directly groupcasts the first communication data 110 based on the first direct communication group 10. Because the first communication data 110 is transmitted in a groupcast manner, the first communication data 110 can be received by the eNB 19 via the transceiver 191.

In this case, because the second direct communication apparatus 13 is outside the communication coverage 116 of the first direct communication apparatus 11, the second direct communication apparatus 13 still can not directly receive the first communication data 110. Accordingly, the second direct communication apparatus 13 will send the first feedback message 130 to the eNB 19 to notify the eNB 19 that it has not received any groupcast message.

On the other hand, because the third direct communication apparatus 31 belongs to the second direct communication group 30 (i.e., does not belong to the first direct communication group 10) in the third embodiment, the first communication data 110 is not intended to be groupcasted to the third direct communication apparatus 31. However, because the third direct communication apparatus 31 is in the communication coverage 116 of the first direct communication apparatus 11, the first communication data 110 will also be received by the third direct communication apparatus 31. Then, the third direct communication apparatus 31 can store the first communication data 110 for subsequent use.

Further speaking, after the first feedback message 130 of the second direct communication apparatus 13 is received by the transceiver 191 of the eNB 19, the processor 193 can decide that the first communication data 110 must be re-forwarded in the first direct communication group 10 according to the second feedback message 130. Then, when the first communication data 110 is re-forwarded and the fourth direct communication apparatus 33 groupcasts a second communication data 330, the third direct communication apparatus 33 will still be subjected to the interference from the transmission signal of the first communication data 110 although it only needs the second communication data 330.

To solve this problem, the third direct communication apparatus 31 can use the first communication data 110 previously stored to perform an interference cancelling procedure. Specifically, because the third direct communication apparatus 31 has the first communication data 110 stored therein, the signal form of data transmission of the first communication data 110 can be known by the third direct communication apparatus 31. Therefore, by use of the first communication data 110 already stored therein, the third direct communication apparatus 31 can cancel the content of the first communication data 110 when the first communication data 110 is received again so as to avoid its interference to the receiving of the second communication data 330.

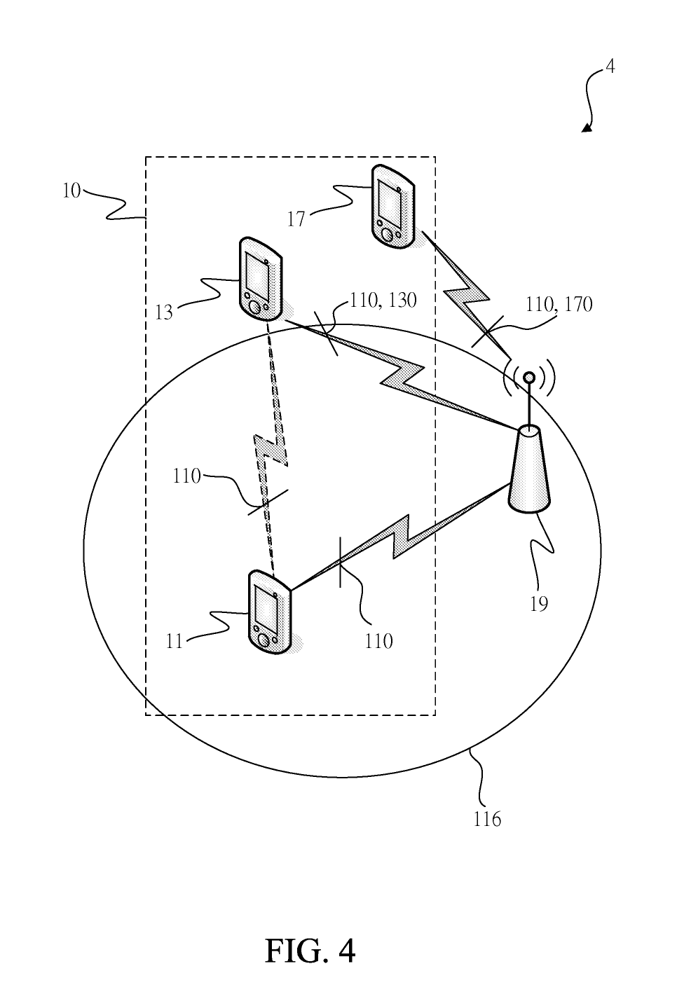

Referring to FIG. 4, there is shown a schematic view of a direct communication system 4 according to a fourth embodiment of the present invention. It should be particularly noted that, the system architecture and the network connection environment of the fourth embodiment are identical to those of the previous embodiments, so elements with the same reference numerals also have the same functions and thus will not be described again. However, the fourth embodiment differs from the previous embodiments in that, the direct communication system 4 further comprises a third direct communication apparatus 17.

Firstly, when the first direct communication apparatus 11 is going to transmit data for communication of the first direct communication group 10 to which it belongs, the first direct communication apparatus 11 directly groupcasts the first communication data 110 based on the first direct communication group 10. Then, because the first communication data 110 is transmitted in a groupcast manner, the first communication data 110 can be received by the eNB 19 via the transceiver 191.

In this case, although the second direct communication apparatus 13 also belongs to the first direct communication group 10, the second direct communication apparatus 13 still can not directly receive the first communication data 110 because the second direct communication apparatus 13 is outside the communication coverage 116 of the first direct communication apparatus 11. Accordingly, the second direct communication apparatus 13 will send the first feedback message 130 to the eNB 19 to notify the eNB 19 that it has not received any groupcast message.

Next, after the first feedback message 130 of the second direct communication apparatus 13 is received by the transceiver 191 of the eNB 19, the processor 193 can decide that the first communication data 110 must be re-forwarded in the first direct communication group 10 according to the first feedback message 130.

On the other hand, the transceiver 191 of the eNB 19 can receive a testing signal 170 from the third direct communication apparatus 17 at the same time. The testing signal 170 is used to perform a communication measurement between the third direct communication apparatus 17 and the eNB 19. Accordingly, the processor 193 of the eNB 19 can determine the communication status between the eNB 19 and the third direct communication apparatus 17 according to the testing signal 170 and then adjust the signal transmission power/encoding mode of the eNB 19 accordingly to ensure normal communication between the third direct communication apparatus 17 and the eNB 19.

It should be particularly noted that, in the fourth embodiment, because the third direct communication apparatus 17 has not correctly received the first communication data 110 either. Therefore, when the processor 193 of the eNB 19 re-groupcasts the first communication data 110 in the first direct communication group 10 via the transceiver 191 based on the signal transmission power/encoding mode, the first communication data 110 from the eNB 19 can also be received by the third direct communication apparatus 17 in addition to the second direct communication apparatus 13.

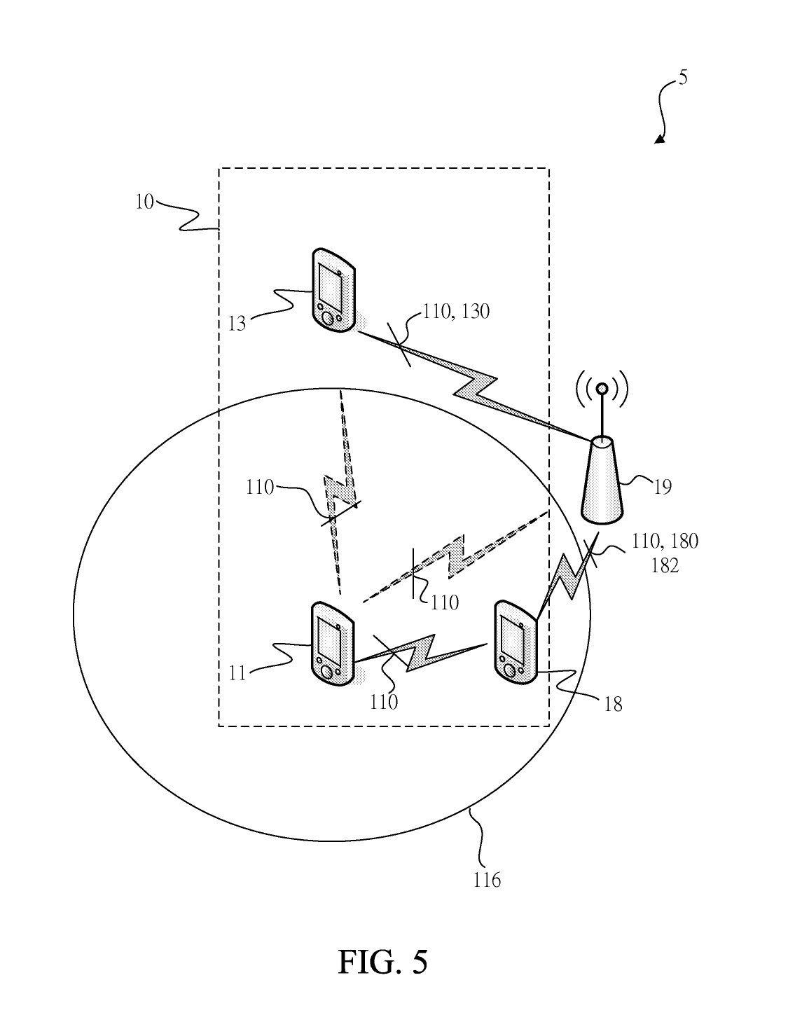

Referring to FIG. 5, there is shown a schematic view of a direct communication system 5 according to a fifth embodiment of the present invention. It should be particularly noted that, the system architecture and the network connection environment of the fifth embodiment are identical to those of the previous embodiments, so elements with the same reference numerals also have the same functions and thus will not be described again. However, the fifth embodiment differs from the previous embodiments in that the direct communication system 5 further comprises a third direct communication apparatus 18.

Firstly, when the first direct communication apparatus 11 is going to transmit data for communication of the first direct communication group 10 to which it belongs, the first direct communication apparatus 11 directly groupcasts the first communication data 110 based on the first direct communication group 10. Then, because the first communication data 110 is transmitted in a groupcast manner, the first communication data 110 can be received by the eNB 19 via the transceiver 191.

In the fifth embodiment, the processor 193 of the eNB 19 determines that the eNB 19 fails to receive the first communication data 110, and then the transceiver 191 of the eNB 19 receives a testing signal 180 from the third direct communication apparatus 18 of the first direct communication group 10. Next, the processor 193 of the eNB 19 firstly determines that the communication between the eNB 19 and the third direct communication apparatus 18 is normal according to the testing signal 180 before data forwarding is performed subsequently.

Afterwards, the transceiver 191 of the eNB 19 receives a second feedback message 182 from the third direct communication apparatus 18. The second feedback message 182 is used to notify the eNB 19 that the third direct communication apparatus 18 has correctly received the first communication data 110. Then, because the third direct communication apparatus 18 has the correct first communication data 110, the processor 193 of the eNB 19 re-receives the correct first communication data 110 from the third direct communication apparatus 18 via the transceiver 191 according to the second feedback message 182.

Similarly, although the second direct communication apparatus 13 also belongs to the first direct communication group 10, the second direct communication apparatus 13 can not directly receive the first communication data 110 because the second direct communication apparatus 13 is outside the communication coverage 116 of the first direct communication apparatus 11. Accordingly, the second direct communication apparatus 13 will send the first feedback message 130 to the eNB 19 to notify the eNB 19 that it has not received any groupcast message, and the processor 193 can decide that the first communication data 110 must be re-forwarded in the first direct communication group 10 according to the first feedback message 130.

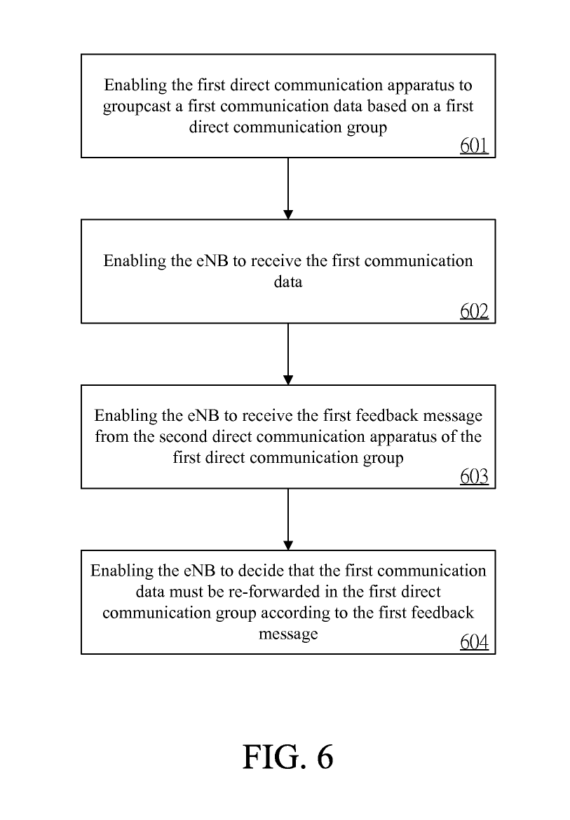

Referring to FIG. 6, there is shown a flowchart diagram of a data forwarding method according to a sixth embodiment of the present invention. The method of the sixth embodiment is used in a direct communication system as well as a first direct communication apparatus and an eNB comprised therein (e.g., the direct communication apparatus 11 and the eNB 19 of the aforesaid embodiments). The detailed steps of the method according to the sixth embodiment are described as follows.

Firstly, when the first direct communication apparatus is going to transmit data for communication of the first direct communication group to which it belongs, step 601 is executed to enable the first direct communication apparatus to groupcast a first communication data based on a first direct communication group. Then, because the first communication data is transmitted in a groupcast manner, step 602 is executed to enable the eNB to receive the first communication data.

Because a second direct communication apparatus of the first direct communication group is outside a communication coverage of the first direct communication apparatus, the second direct communication apparatus can not directly receive the first communication data. Accordingly, the second direct communication apparatus will send a first feedback message to the eNB and step 603 is executed to enable the eNB to receive the first feedback message from the second direct communication apparatus of the first direct communication group. Finally, step 604 is executed to enable the eNB to decide that the first communication data must be re-forwarded in the first direct communication group according to the first feedback message.

Similarly, the aforesaid feedback massage comprises the Bit Error Rate (BET), the Channel Quality Indicator (CQI), the Reference Signal Received Power (RSRP), the Reference Signal Received Quality (RSRQ), the Signal to Interference plus Noise Ratio (SINR), the pathloss measurement or other index values adapted to determine the data forwarding quality or the correctness of data forwarding.

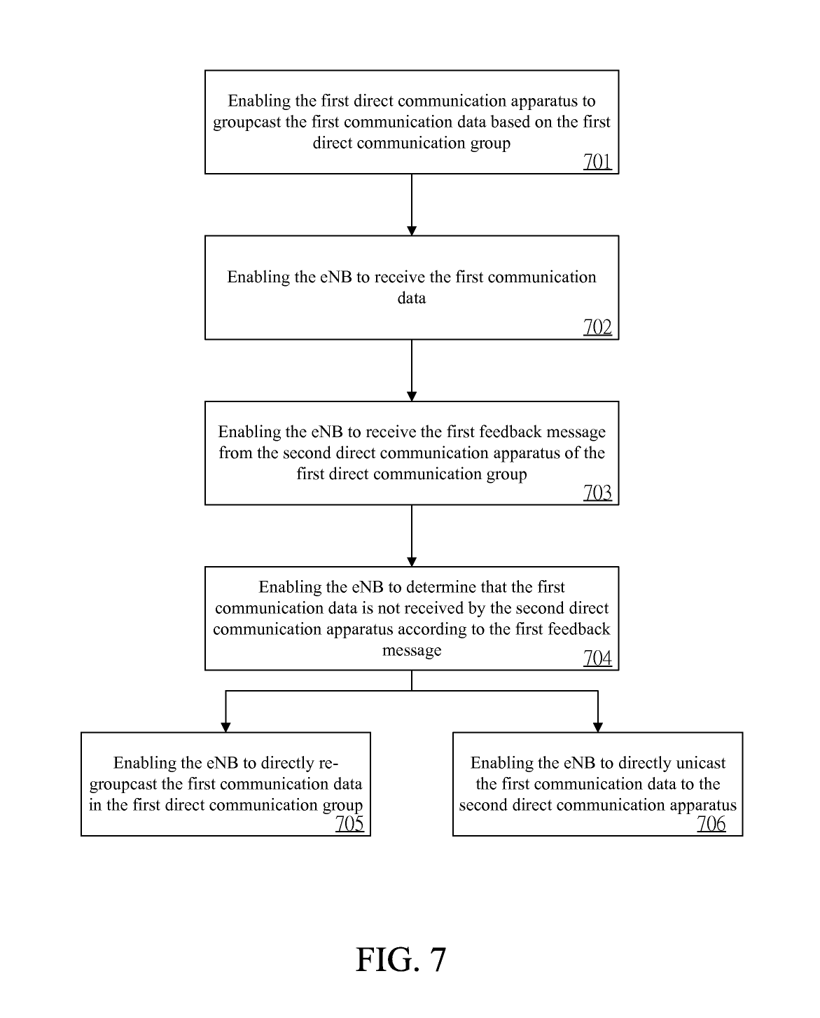

Referring to FIG. 7, there is shown a flowchart diagram of a data forwarding method according to a seventh embodiment of the present invention. The method of the seventh embodiment is used in a direct communication system as well as a first direct communication apparatus and an eNB comprised therein (e.g., the direct communication apparatus 11 and the eNB 19 of the aforesaid embodiments). The detailed steps of the method of the seventh embodiment are described as follows.

Similarly, when the first direct communication apparatus is going to transmit data for communication of the first direct communication group to which it belongs, step 701 is executed to enable the first direct communication apparatus to groupcast the first communication data based on the first direct communication group. Then, because the first communication data is transmitted in a groupcast manner, step 702 is executed to enable the eNB to receive the first communication data.

Because a second direct communication apparatus of the first direct communication group is outside a communication coverage of the first direct communication apparatus, the second direct communication apparatus can not directly receive the first communication data. Accordingly, the second direct communication apparatus will send a first feedback message to the eNB and step 703 is executed to enable the eNB to receive the first feedback message from the second direct communication apparatus of the first direct communication group.

Subsequently, step 704 is executed to enable the eNB to determine that the first communication data is not received by the second direct communication apparatus according to the first feedback message. Next, the eNB can decide by itself in which manner the first communication data needs to be re-forwarded. Specifically, step 705 may be executed to enable the eNB to directly re-groupcast the first communication data in the first direct communication group, or step 706 may be executed to enable the eNB to directly unicast the first communication data to the second direct communication apparatus.

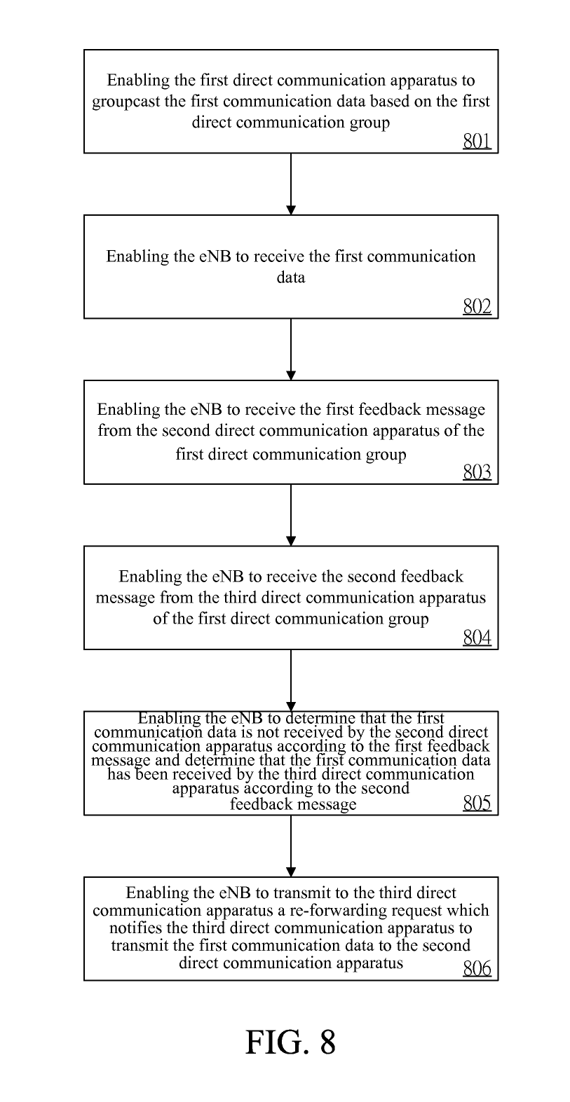

Referring to FIG. 8, there is shown a flowchart diagram of a data forwarding method according to an eighth embodiment of the present invention. The method of the eighth embodiment is used in a direct communication system as well as a first direct communication apparatus and an eNB comprised therein (e.g., the direct communication apparatus 11 and the eNB 19 of the aforesaid embodiments). The detailed steps of the method of the eighth embodiment are described as follows.

Firstly, when the first direct communication apparatus is going to transmit data for communication of the first direct communication group to which it belongs, step 801 is executed to enable the first direct communication apparatus to groupcast the first communication data based on the first direct communication group. Then, because the first communication data is transmitted in a groupcast manner, step 802 is executed to enable the eNB to receive the first communication data.

Because a second direct communication apparatus of the first direct communication group is outside the communication coverage of the first direct communication apparatus, the second direct communication apparatus can not directly receive the first communication data. On the other hand, because a third direct communication apparatus of the first direct communication group is in the communication coverage of the first direct communication apparatus, the first communication data can be directly received by the third direct communication apparatus.

Accordingly, the second direct communication apparatus and the third direct communication apparatus will send a first feedback message and a second feedback message to the eNB respectively. Step 803 is executed to enable the eNB to receive the first feedback message from the second direct communication apparatus of the first direct communication group. At the same time, step 804 is executed to enable the eNB to receive the second feedback message from the third direct communication apparatus of the first direct communication group.

Next, step 805 is executed to enable the eNB to determine that the first communication data is not received by the second direct communication apparatus according to the first feedback message and determine that the first communication data has been received by the third direct communication apparatus according to the second feedback message. Finally, step 806 is executed to enable the eNB to transmit to the third direct communication apparatus a re-forwarding request which notifies the third direct communication apparatus to transmit the first communication data to the second direct communication apparatus.

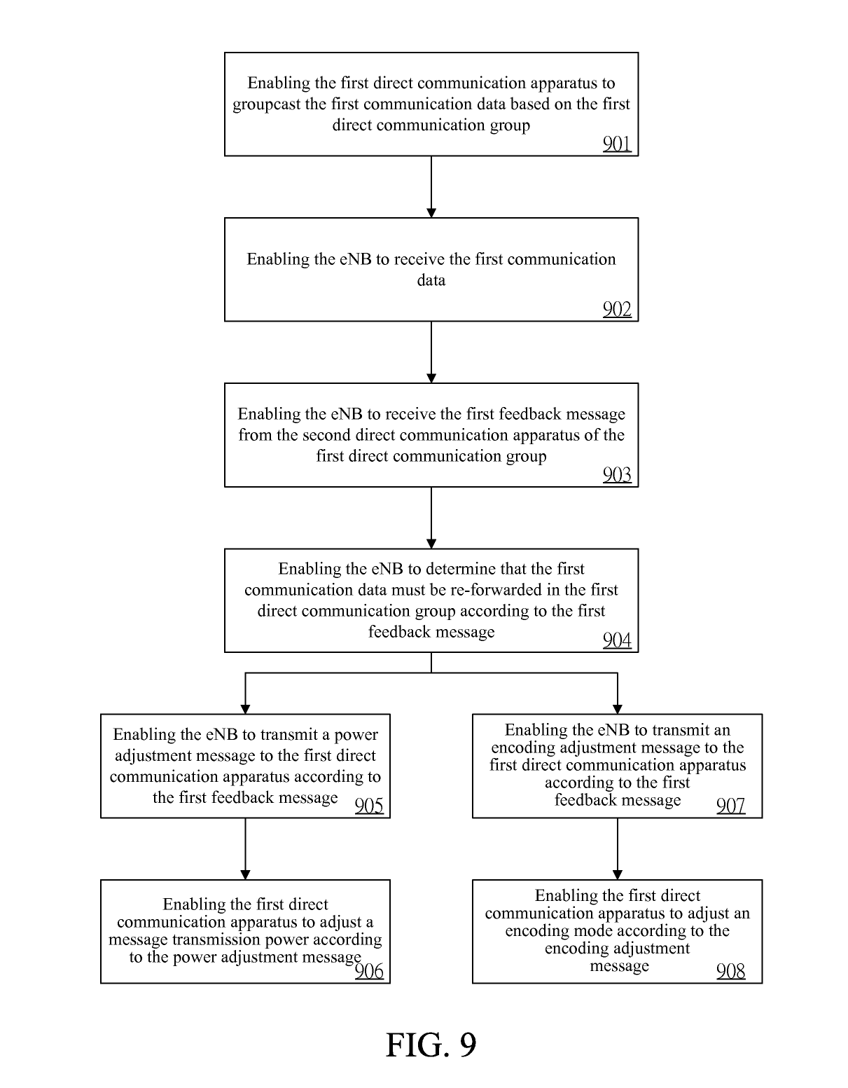

Referring to FIG. 9, there is shown a flowchart diagram of a data forwarding method according to a ninth embodiment of the present invention. The method of the ninth embodiment is used in a direct communication system as well as a first direct communication apparatus and an eNB comprised therein (e.g., the direct communication apparatus 11 and the eNB 19 of the aforesaid embodiments). The detailed steps of the method of the ninth embodiment are described as follows.

Similarly, when the first direct communication apparatus is going to transmit data for communication of the first direct communication group to which it belongs, step 901 is executed to enable the first direct communication apparatus to groupcast the first communication data based on the first direct communication group. Then, because the first communication data is transmitted in a groupcast manner, step 902 is executed to enable the eNB to receive the first communication data.

Because a second direct communication apparatus of the first direct communication group is outside the communication coverage of the first direct communication apparatus, the second direct communication apparatus can not directly receive the first communication data. Accordingly, the second direct communication apparatus will send a first feedback message to the eNB and step 903 is executed to enable the eNB to receive the first feedback message from the second direct communication apparatus of the first direct communication group. Step 904 is executed to enable the eNB to determine that the first communication data must be re-forwarded in the first direct communication group according to the first feedback message.

Next, in order for the data groupcasted later by the first direct communication apparatus to be received by the second direct communication apparatus, the eNB may further notify the first direct communication apparatus to adjust message transmission parameters. Specifically, step 905 may be executed to enable the eNB to transmit a power adjustment message to the first direct communication apparatus according to the first feedback message. Next, step 906 is executed to enable the first direct communication apparatus to adjust a message transmission power according to the power adjustment message.

On the other hand, step 907 may also be executed to enable the eNB to transmit an encoding adjustment message to the first direct communication apparatus according to the first feedback message. Next, step 908 is executed to enable the first direct communication apparatus to adjust an encoding mode according to the encoding adjustment message. In this way, the message forwarding efficiency of the first direct communication apparatus in the first direct communication group is enhanced.

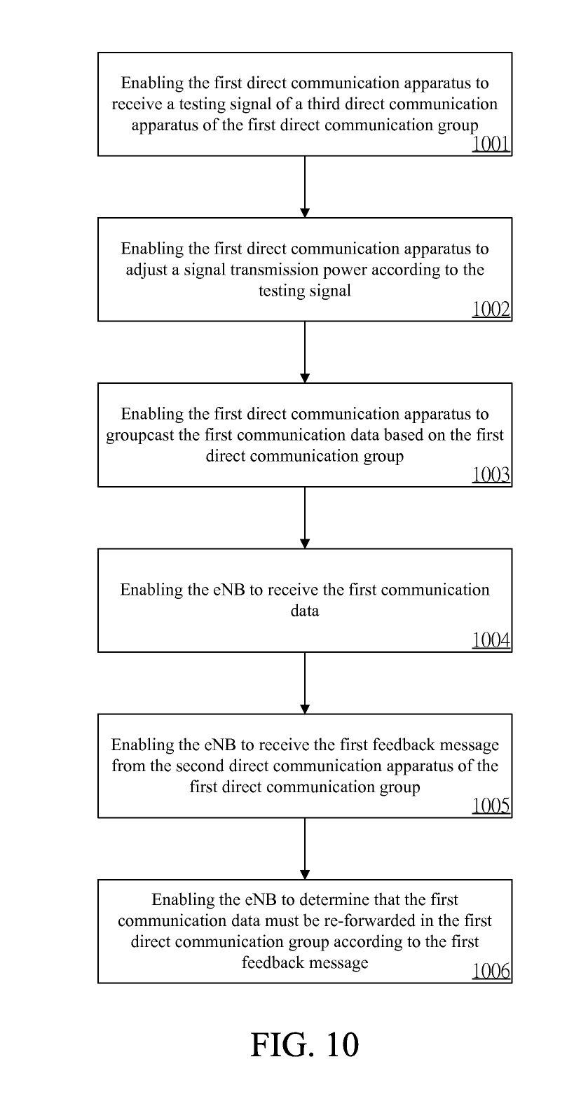

Referring to FIG. 10, there is shown a flowchart diagram of a data forwarding method according to a tenth embodiment of the present invention. The method of the tenth embodiment is used in a direct communication system as well as a first direct communication apparatus and an eNB comprised therein (e.g., the direct communication apparatus 11 and the eNB 19 of the aforesaid embodiments). The detailed steps of the method of the tenth embodiment are described as follows.

Firstly, power adjustment may also be accomplished before a direct communication apparatus groupcasts a communication data. Step 1001 is executed to enable the first direct communication apparatus to receive a testing signal of a third direct communication apparatus of the first direct communication group. Next, step 1002 is executed to enable the first direct communication apparatus to adjust a signal transmission power according to the testing signal. In this way, when a groupcast is initiated by the first direct communication apparatus, it can be ensured that the communication data can be directly received by the third direct communication apparatus.

Next, when the first direct communication apparatus is going to transmit data for communication of the first direct communication group to which it belongs, step 1003 is executed to enable the first direct communication apparatus to groupcast the first communication data based on the first direct communication group. Then, because the first communication data is transmitted in a groupcast manner, step 1004 is executed to enable the eNB to receive the first communication data.

Because a second direct communication apparatus of the first direct communication group is outside the communication coverage of the first direct communication apparatus, the second direct communication apparatus can not directly receive the first communication data. Accordingly, the second direct communication apparatus will send a first feedback message to the eNB and step 1005 is executed to enable the eNB to receive the first feedback message from the second direct communication apparatus of the first direct communication group. Finally, step 1006 is executed to enable the eNB to determine that the first communication data must be re-forwarded in the first direct communication group according to the first feedback message.

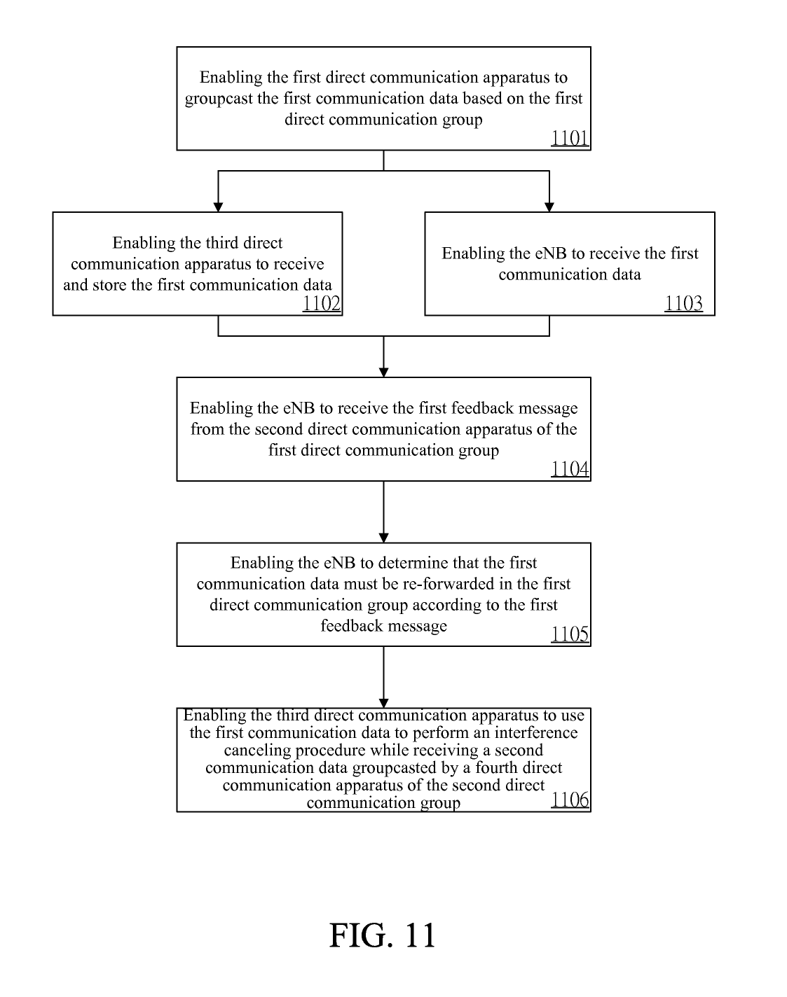

Referring to FIG. 11, there is shown a flowchart diagram of a data forwarding method according to an eleventh embodiment of the present invention. The method of the eleventh embodiment is used in a direct communication system as well as a first direct communication apparatus, a third direct communication apparatus and an eNB comprised therein (e.g., the direct communication apparatuses 11, 15 and the eNB 19 of the aforesaid embodiments). The detailed steps of the method of the eleventh embodiment are described as follows.

Firstly, when the first direct communication apparatus is going to transmit data for communication of the first direct communication group to which it belongs, step 1101 is executed to enable the first direct communication apparatus to groupcast the first communication data based on the first direct communication group. Then, because the first communication data is transmitted in a groupcast manner, step 1102 is executed to enable the third direct communication apparatus to receive and store the first communication data. At the same time, step 1103 is executed to enable the eNB to receive the first communication data.

Because a second direct communication apparatus of the first direct communication group is outside the communication coverage of the first direct communication apparatus, the second direct communication apparatus can not directly receive the first communication data. Accordingly, the second direct communication apparatus will send a first feedback message to the eNB and step 1104 is executed to enable the eNB to receive the first feedback message from the second direct communication apparatus of the first direct communication group. Step 1105 is executed to enable the eNB to determine that the first communication data must be re-forwarded in the first direct communication group according to the first feedback message.

Because the first communication data not needed is continuously received by the third direct communication apparatus in the subsequent message receiving and processing process, interference is caused to the message processing. Therefore, step 1106 is executed to enable the third direct communication apparatus to use the first communication data to perform an interference canceling procedure while receiving a second communication data groupcasted by a fourth direct communication apparatus of the second direct communication group.

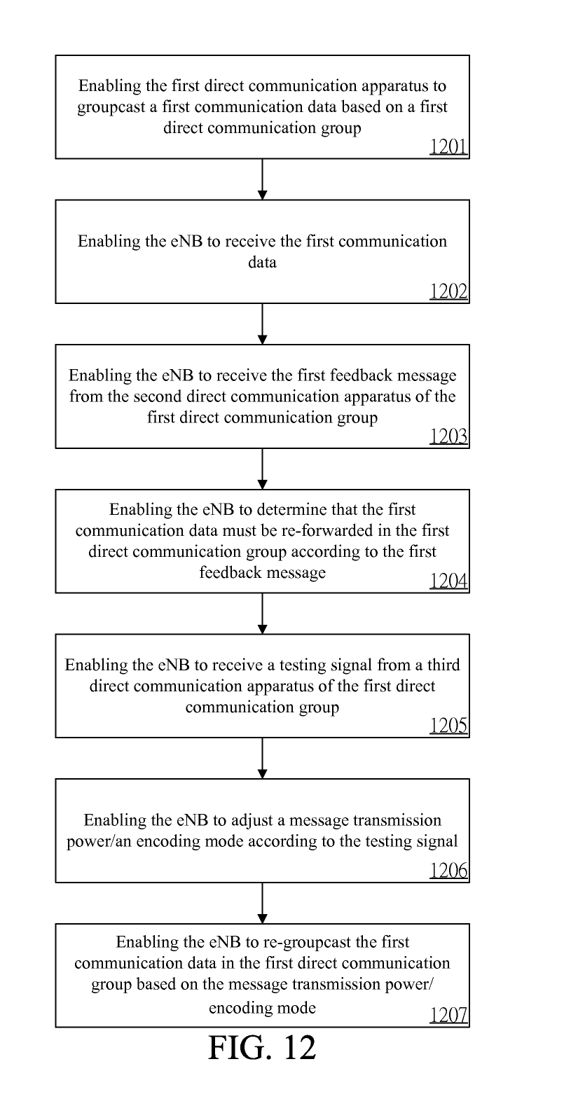

Referring to FIG. 12, there is shown a flowchart diagram of a data forwarding method according to a twelfth embodiment of the present invention. The method of the twelfth embodiment is used in a direct communication system as well as a first direct communication apparatus and an eNB comprised therein (e.g., the direct communication apparatus 11 and the eNB 19 of the aforesaid embodiments). The detailed steps of the method of the twelfth embodiment are described as follows.

Firstly, when the first direct communication apparatus is going to transmit data for communication of the first direct communication group to which it belongs, step 1201 is executed to enable the first direct communication apparatus to groupcast a first communication data based on a first direct communication group. Then, because the first communication data is transmitted in a groupcast manner, step 1202 is executed to enable the eNB to receive the first communication data.

Then, because a second direct communication apparatus of the first direct communication group is outside the communication coverage of the first direct communication apparatus, the second direct communication apparatus can not directly receive the first communication data. Accordingly, the second direct communication apparatus will send a first feedback message to the eNB and step 1203 is executed to enable the eNB to receive the first feedback message from the second direct communication apparatus of the first direct communication group. Step 1204 is executed to enable the eNB to determine that the first communication data must be re-forwarded in the first direct communication group according to the first feedback message.

Next, step 1205 is executed to enable the eNB to receive a testing signal from a third direct communication apparatus of the first direct communication group. Step 1206 is executed to enable the eNB to adjust a message transmission power/an encoding mode according to the testing signal. Finally, step 1207 is executed to enable the eNB to re-groupcast the first communication data in the first direct communication group based on the message transmission power/encoding mode so that the first communication data can be received by the second direct communication apparatus and the third direct communication apparatus.

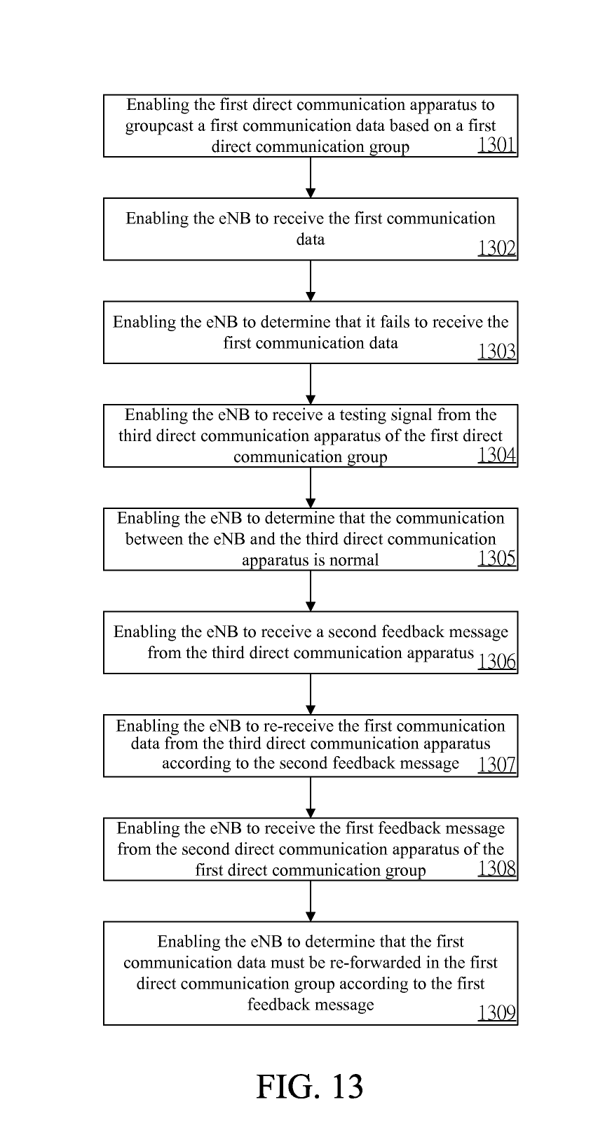

Referring to FIG. 13, there is shown a flowchart diagram of a data forwarding method according to a thirteenth embodiment of the present invention. The method of the thirteenth embodiment is used in a direct communication system as well as a first direct communication apparatus and an eNB comprised therein (e.g., the direct communication apparatus 11 and the eNB 19 of the aforesaid embodiments). The detailed steps of the method of the thirteenth embodiment are described as follows.

Firstly, when the first direct communication apparatus is going to transmit data for communication of the first direct communication group to which it belongs, step 1301 is executed to enable the first direct communication apparatus to groupcast a first communication data based on a first direct communication group. Then, because the first communication data is transmitted in a groupcast manner, step 1302 is executed to enable the eNB to receive the first communication data. Specifically, the first direct communication group comprises the first direct communication apparatus, a second direct communication apparatus and a third direct communication apparatus.

Next, step 1303 is executed to enable the eNB to determine that it fails to receive the first communication data. Step 1304 is executed to enable the eNB to receive a testing signal from the third direct communication apparatus of the first direct communication group. Step 1305 is executed to enable the eNB to determine that the communication between the eNB and the third direct communication apparatus is normal.

Subsequently, step 1306 is executed to enable the eNB to receive from the third direct communication apparatus a second feedback message which is used to notify the eNB that the third direct communication apparatus has correctly received the first communication data. Step 1307 is executed to enable the eNB to re-receive the first communication data from the third direct communication apparatus according to the second feedback message.

Because the second direct communication apparatus of the first direct communication group is outside the communication coverage of the first direct communication apparatus, the second direct communication apparatus can not directly receive the first communication data. Accordingly, the second direct communication apparatus will send a first feedback message to the eNB and step 1308 is executed to enable the eNB to receive the first feedback message from the second direct communication apparatus of the first direct communication group. Finally, step 1309 is executed to enable the eNB to determine that the first communication data must be re-forwarded in the first direct communication group according to the first feedback message.

According to the above descriptions, through the coordination and cooperation between the eNB and the direct communication apparatuses, the direct communication system and the data forwarding method thereof of the present invention can accomplish the re-forwarding of data more efficiently when a part of the direct communication apparatuses fail to receive the groupcast data, thus making an improvement on the shortcomings of the prior art.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A direct communication system, comprising:
a first direct communication apparatus belonging to a first direct communication group;
an evolved NodeB (eNB);
wherein the first direct communication apparatus groupcasts a first communication data based on the first direct communication group, and the eNB receives the first communication data and receives a first feedback message from a second direct communication apparatus of the first direct communication group, and the eNB further decides that the first communication data must be re-forwarded in the first direct communication group according to the first feedback message.

2. The direct communication system as claimed in claim 1, wherein the eNB further determines that the first communication data is not received by the second direct communication apparatus according to the first feedback message, and re-groupcasts the first communication data directly in the first direct communication group.

3. The direct communication system as claimed in claim 1, wherein the eNB further determines that the first communication data is not received by the second direct communication apparatus according to the first feedback message, and directly unicasts the first communication data to the second direct communication apparatus.

4. The direct communication system as claimed in claim 1, wherein the eNB further receives a second feedback message from a third direct communication apparatus of the first direct communication group, determines that the first communication data is not received by the second direct communication apparatus according to the first feedback message and determines that the first communication data has been received by the third direct communication apparatus according to the second feedback message, and then the eNB transmits to the third direct communication apparatus a re-forwarding request which notifies the third direct communication apparatus to transmit the first communication data to the second direct communication apparatus.

5. The direct communication system as claimed in claim 1, wherein the eNB further transmits a power adjustment message to the first direct communication apparatus according to the first feedback message so that the first direct communication apparatus adjusts a message transmission power according to the power adjustment message.

6. The direct communication system as claimed in claim 1, wherein the eNB further transmits an encoding adjustment message to the first direct communication apparatus according to the first feedback message so that the first direct communication apparatus adjusts an encoding mode according to the encoding adjustment message.

7. The direct communication system as claimed in claim 1, wherein the eNB further receives a testing signal from a third direct communication apparatus of the first direct communication group and adjusts a message transmission power according to the testing signal, and then the eNB re-groupcasts the first communication data in the first direct communication group based on the message transmission power.

8. The direct communication system as claimed in claim 1, wherein the eNB further receives a testing signal from a third direct communication apparatus of the first direct communication group and adjusts an encoding mode according to the testing signal, and then the eNB re-groupcasts the first communication data in the first direct communication group based on the encoding mode.

9. The direct communication system as claimed in claim 1, further comprising:
a third direct communication apparatus belonging to a second direct communication group;
wherein the third direct communication apparatus receives and stores the first communication data groupcasted by the first direct communication apparatus, and uses the first communication data to perform an interference canceling procedure while receiving a second communication data groupcasted by a fourth direct communication apparatus of the second direct communication group.

10. The direct communication system as claimed in claim 1, wherein the first direct communication apparatus further receives a testing signal from a third direct communication apparatus of the first direct communication group, and adjusts a message transmission power according to the testing signal.

11. The direct communication system as claimed in claim 1, wherein the eNB further determines that it fails to receive the first communication data, and receives a testing signal from a third direct communication apparatus of the first direct communication group and determines that the communication between the eNB and the third direct communication apparatus is normal according to the testing signal, and the eNB further receives from the third direct communication apparatus a second feedback message which is used to notify the eNB that the third direct communication apparatus has correctly received the first communication data, and then the eNB re-receives the first communication data from the third direct communication apparatus according to the second feedback message.

12. An evolved NodeB (eNB) for use in a direct communication system, the direct communication system further comprising a first direct communication apparatus that belongs to a first direct communication group, the eNB comprising:
a transceiver, being configured to receive a first communication data groupcasted by the first direct communication apparatus, and receive a first feedback message from a second direct communication apparatus of the first direct communication group; and
a processor, being configured to decide that the first communication data must be re-forwarded in the first direct communication group according to the first feedback message.

13. The eNB as claimed in claim 12, wherein the processor is further configured to determine that the first communication data is not received by the second direct communication apparatus according to the first feedback message, and the transceiver is further configured to re-groupcast the first communication data directly in the first direct communication group.

14. The eNB as claimed in claim 12, wherein the processor is further configured to determine that the first communication data is not received by the second direct communication apparatus according to the first feedback message, and the transceiver is further configured to directly unicast the first communication data to the second direct communication apparatus.

15. The eNB as claimed in claim 12, wherein the transceiver is further configured to receive a second feedback message from a third direct communication apparatus of the first direct communication group, and the processor is further configured to determine that the first communication data is not received by the second direct communication apparatus according to the first feedback message and determine that the first communication data has been received by the third direct communication apparatus according to the second feedback message, and the transceiver is further configured to transmit to the third direct communication apparatus a re-forwarding request which notifies the third direct communication apparatus to transmit the first communication data to the second direct communication apparatus.

16. The eNB as claimed in claim 12, wherein the processor is further configured to transmit a power adjustment message to the first direct communication apparatus via the transceiver according to the first feedback message so that the first direct communication apparatus adjusts a message transmission power according to the power adjustment message.

17. The eNB as claimed in claim 12, wherein the processor is further configured to transmit an encoding adjustment message to the first direct communication apparatus via the transceiver according to the first feedback message so that the first direct communication apparatus adjusts an encoding mode according to the encoding adjustment message.

18. The eNB as claimed in claim 12, wherein the transceiver is further configured to receive a testing signal from a third direct communication apparatus of the first direct communication group, the processor is further configured to adjust a message transmission power according to the testing signal, and the transceiver is further configured to re-groupcast the first communication data in the first direct communication group based on the message transmission power.

19. The eNB as claimed in claim 12, wherein the transceiver is further configured to receive a testing signal from a third direct communication apparatus of the first direct communication group, the processor is further configured to adjust an encoding mode according to the testing signal, and the transceiver is further configured to re-groupcast the first communication data in the first direct communication group based on the encoding mode.

20. The eNB as claimed in claim 12, wherein the processor is further configured to determine that the eNB fails to receive the first communication data, the transceiver is further configured to receive a testing signal from a third direct communication apparatus of the first direct communication group, the processor is further configured to determine that the communication between the eNB and the third direct communication apparatus is normal according to the testing signal, the transceiver is further configured to receive from the third direct communication apparatus a second feedback message which is used to notify the eNB that the third direct communication apparatus has correctly received the first communication data, and the processor is further configured to re-receive the first communication data from the third direct communication apparatus via the transceiver according to the second feedback message.
